(19) United States
(12) Patent Application Publication
(10) Pub. No.: US 2022/0379241 A1
(43) Pub. Date: Dec. 1, 2022

(54) FLOCCULATING, GRADING, AND DEWATERING DEVICE

(71) Applicant: Anhui University of Science and Technology, Huainan (CN)

(72) Inventors: Wei Zhou, Huainan (CN); Lingling Wang, Huainan (CN); Jianbo Li, Huainan (CN); Liang Li, Huainan (CN); Liangliang Liu, Huainan (CN); Shujie Wang, Huainan (CN); Jinbo Zhu, Huainan (CN); Fanfei Min, Huainan (CN)

(73) Assignee: Anhui University of Science and Technology, Huainan (CN)

(21) Appl. No.: 17/701,566

(22) Filed: Mar. 22, 2022

(30) Foreign Application Priority Data
Jun. 1, 2021 (CN) 202110609126.9

(51) Int. Cl. B01D 21/24; B01D 21/08; B01D 21/00; B04B 3/06

(52) U.S. Cl. CPC B01D 21/245; B01D 21/08; B01D 21/0021; B01D 21/2427; B04B 3/06; B01D 2221/04

(57) ABSTRACT

A flocculating, grading, and dewatering device includes a tank body, a mixing zone, a flocculent settling zone, a centrifugal dewatering zone, and a particle screening zone. An initial material is mixed with a chemical agent for a flocculation reaction, a lower sediment material settles and an upper liquid overflows. In the centrifugal dewatering zone, a screen basket is allowed to rotate to facilitate a centrifugal movement of the sediment material, water in the sediment material moves into a guide cavity and then flows to a centrifugate outlet, and then a dewatered material in the screen basket is removed out of the screen basket. In the particle screening zone, a screening mechanism screens particles of different size grades in the dewatered material, and water generated flows downward and is discharged; liquids discharged from the centrifugate outlet and the overflow port are combined, and then discharged through a mixed liquid outlet.

### CROSS REFERENCE TO THE RELATED APPLICATIONS

This application is based upon and claims priority to Chinese patent application No. 202110609126.9, filed on Jun. 1, 2021, the entire contents of which are herein incorporated by reference.

### TECHNICAL FIELD

The present disclosure relates to the field of solid-liquid separation (SLS) devices, and in particular to a flocculating, grading, and dewatering device.

### BACKGROUND

In the aspect of wet coal preparation, a water-containing coal material needs to be treated by procedures such as stepwise flocculating, dewatering, and grading.

Existing technologies for material dewatering mainly include the following:

(1) Dewatering Screen

A dewatering screen is a dewatering device most used in coal preparation plants, and is also a dewatering device that must be equipped in wet coal preparation plants. Chinese patent CN108800849A discloses an adjustable linear dewatering screen. The linear dewatering screen has a compact structure and is easy to operate, but a rotational speed of a vibration exciter tends to slow down and a temperature of a bearing tends to rise, which causes the linear screen to fail to operate normally.

(2) Centrifugal Dewatering Device

Centrifugal dewatering devices in coal preparation plants in China are divided into two categories according to particle sizes of treated materials: scraper discharge centrifugal dewatering devices and vibrating discharge centrifugal dewatering devices, which treat 13 mm to 0.5 mm slack coal (fine coal and medium-sized coal) based on centrifugal filtration; and scroll discharge centrifugal settling dewatering devices and centrifugal settling and filtration dewatering devices, which treat a 0.5 mm to 0 mm material based on centrifugal settling or a combination of centrifugal settling and centrifugal filtration.

Chinese patent CN108855638A discloses a vibrating centrifugal dewatering device. The vibrating centrifugal dewatering device has a prominent dewatering effect and can be used in continuous production, but has a complex structure and cannot screen coarse and fine particles.

(3) Vacuum Filtration Device

Vacuum filtration devices include disc filters, folding belt filters, horizontal belt filters, and the like. The disc vacuum filters are the most widely used, and possessed by almost all factories with a flotation process or a coal slime recovery process, which is mainly used for dewatering of clean coal and coal slime in flotation, and was also used for dewatering of materials in flotation in the early days.

Chinese patent CN103537129A discloses a disc vacuum filter, which has the disadvantage that a filter cake has a high water content, generally of 10% or more, indicating a poor dewatering effect.

(4) Pressure Filtration Device

There are three types of pressure filtration devices at present: chamber pressure filter (referred to as pressure filter), which achieves the dewatering by passing a suspension through a filter medium under the action of a pressure difference; belt extruder, which squeezes a material structure in a decrescent space through a mechanical pressure to separate a liquid, thereby achieving the purpose of dewatering; and continuous pressure filter, which achieves the dewatering by passing ore pulp through a filter medium under a pressure of compressed air. The pressure filtration devices are also quality-control devices widely used in coal preparation plants for dewatering of fine-grained materials. In particular, the chamber pressure filters are currently the most effective quality-control devices capable of treating fine-grained, high-ash, and viscous materials. The belt extruders and continuous pressure filters are suitable for recovery and dewatering of a coarse part in a fine-grained material, but prone to causing a filtrate to have a relatively high concentration.

Chinese patent CN10107226A discloses a belt pressure filter, which cannot separate a coarse-particle material from a fine-particle material, and has some limitations.

In summary, the existing processes are relatively complex; and multiple different devices are usually required to complete the entire process, and it takes time for materials to flow between the different devices, which increases a time gap between operations, results in low production efficiency, and cannot adapt to the needs of automated production.

### SUMMARY

The present disclosure is mainly intended to provide a flocculating, grading, and dewatering device, which can achieve flocculating, dewatering, grading, and other treatments on a material through one device, thereby improving the production efficiency.

In order to achieve the above objective, the present disclosure provides a flocculating, grading, and dewatering device, including a tank body arranged vertically, and a mixing zone, a flocculent settling zone, a centrifugal dewatering zone, and a particle screening zone that are sequentially arranged from top to bottom in the tank body, where a feeding port for feeding an initial material into the mixing zone is formed at an upper end of the tank body; an agent-feeding mechanism is provided in the mixing zone, and the agent-feeding mechanism is configured to add a chemical agent participating in a flocculation reaction to the initial material in the mixing zone; the flocculent settling zone is provided with a sedimentation tank for receiving a sediment material settled from the mixed zone; an overflow port for overflow of a liquid above the sediment material is formed on a side wall of the tank body in the flocculent settling zone, and the overflow port is lower than the feeding port and higher than an inlet of the sedimentation tank; the centrifugal dewatering zone is provided with a rotary-fitted bowl-shaped screen basket and a centrifugal drive assembly that drives the screen basket to rotate; the screen basket is configured to receive the sediment material discharged from the sedimentation tank; a rotating shaft of the screen basket is arranged in a vertical direction; liquid-through holes for water separated from the sediment material to pass through are formed on a side wall of the screen basket; a guide cavity communicating with the liquid-through holes is formed on an outer peripheral side of the screen basket; the guide cavity is in seal fit with an outer side wall of the screen basket and an inner wall of the tank body, and a centrifugate outlet communicating with the guide cavity is formed on the tank body; the particle screening zone is provided with a screening mechanism, and the screening mechanism is configured to screen particles of different size grades in a dewatered material discharged from the screen basket; a drain port for discharging water generated in a screening process is formed at a bottom of the tank body; an overflow dispersing pipe is also provided, and the overflow dispersing pipe communicates with the overflow port and the centrifugate outlet; and a mixed liquid outlet for discharging an overflow liquid and/or a centrifugate is formed on the overflow dispersing pipe.

Preferably, vibration assemblies may also be provided at an outer side of the tank body in the centrifugal dewatering zone, and the vibration assemblies may be arranged at a specified interval along a circumference of the tank body; and the vibration assemblies may be configured to drive the screen basket to vibrate in an axial direction, such that the sediment material in the screen basket vibrates up and down.

Preferably, the screen basket may include a screen basket main body and a material receiving member; a passage gap for the dewatered material to pass may be formed between the screen basket main body and the inner wall of the tank body; the material receiving member may be a ring-shaped member arranged concentrically with the screen basket main body and may be arranged in the passage gap; the material receiving member may be configured to receive the dewatered material discharged from the screen basket main body; an inner ring edge of the material receiving member may be in sealed connection with an edge of the screen basket main body; an outer ring edge of the material receiving member may be in seal fit with the inner wall of the tank body; and a discharge port for downward discharging the dewatered material may be formed on the material receiving member, and the discharge port and the guide cavity may be arranged at a specified interval.

Preferably, an upper surface of the material receiving member may be lower than a top edge of the screen basket main body; the top edge of the screen basket main body may extend downward and may be connected to the inner ring edge of the material receiving member; and the discharge port may be formed at a lower part of the upper surface of the material receiving member.

Preferably, the material receiving member may be formed by an upper side cavity wall of the guide cavity; a bottom of the guide cavity may be lower than a bottom of the screen basket; and the centrifugate outlet may be arranged corresponding to the bottom of the guide cavity.

Preferably, a stirring mechanism for mixing the initial material with the chemical agent may also be provided in a middle part of the mixing zone; and the stirring mechanism may include a stirring shaft arranged vertically and stirring blades arranged on the stirring shaft.

Preferably, a pusher mechanism for pushing the initial material toward the stirring mechanism may also be provided in the mixing zone; the pusher mechanism may include a push plate movably assembled in a radial direction of the tank body; an empty part may be provided in a middle part of the push plate, and a flexible diaphragm may be arranged in the empty part; the diaphragm may be configured to generate a fluctuation during a reciprocating movement process of the push plate and make a solid substance dispersed in the material; and the push plate may be connected to a pusher drive assembly that adjusts a radial movement of the push plate along the tank body.

Preferably, the agent-feeding mechanism may be composed of a jet mixing assembly; the jet mixing assembly may include an agent-feeding pipe and an agent-feeding pump; and the agent-feeding pump may be connected in series to an outlet end of the agent-feeding pipe and may be configured to spray the chemical agent flowing into an inlet end of the agent-feeding pipe into the initial material.

Preferably, the flocculent settling zone may be further provided with an inverted conical guide pipe, and the guide pipe may be arranged above the sedimentation tank; an upper port of the guide pipe may communicate with the mixing zone, and a lower port of the guide pipe and a mouth of the sedimentation tank may be arranged at a specified interval; the mouth of the sedimentation tank may be arranged in a tapered shape from top to bottom; a lower end of a tank wall of the sedimentation tank may extend downward to form a transition guide pipe; a lower end of the transition guide pipe may extend into the screen basket and may be arranged at a specified interval from the bottom of the screen basket; a projection range of the transition guide pipe on the bottom of the screen basket may be smaller than an arrangement range of the bottom of the screen basket; and the transition guide pipe may be configured to guide the sediment material into the screen basket.

Preferably, the screening mechanism may include a first vibrating screen and a second vibrating screen that are arranged in a vertical direction at a specified interval; the first vibrating screen and the second vibrating screen may be configured to achieve vibratory screening of particles of different size grades; a sieve fraction of the first vibrating screen may be larger than a sieve fraction of the second vibrating screen; a part of the tank body corresponding to the particle screening zone may be in an inverted cone shape; a side of the first vibrating screen may be provided with a first collection tank configured to collect particles retained on the first vibrating screen, and a side of the second vibrating screen may be provided with a second collection tank configured to collect particles retained on the second vibrating screen; and water produced by the first vibrating screen and the second vibrating screen during a vibratory screening process may be discharged through the drain port.

Compared with the prior art, the present disclosure has the following beneficial effects.

(1) In the flocculating, grading, and dewatering device provided by the present disclosure, an initial material is fed through a feeding port at an upper end of a tank body, then a chemical agent is added to the initial material through an agent-feeding mechanism in a mixing zone to conduct a flocculation reaction, and after the initial material undergoes the flocculation reaction, a sediment material produced from the initial material settles into a sedimentation tank and a liquid above the sediment material overflows through an overflow port; in a centrifugal dewatering zone, a screen basket is allowed to rotate, such that the sediment material falling into the screen basket undergoes a centrifugal movement, water in the sediment material is separated, moves into a guide cavity through a liquid-through hole on a side wall of the screen basket, and then is discharged through a centrifugate outlet, and then a dewatered material in the screen basket is removed out of the screen basket after the centrifugal movement; in a particle screening zone, a screening mechanism screens particles of different size grades in the dewatered material discharged from the screen basket, and water generated during the screening process flows downward and is discharged through a drain port; and liquids discharged from the centrifugate outlet and the overflow port are combined through an overflow dispersing pipe, and then discharged through a mixed liquid outlet of the overflow dispersing pipe. With the above solution, the flocculent settling, dewatering, and grading treatments can be conducted on a water-containing material at once, which helps to improve the dewatering effect and can also achieve the purpose of screening solid particles, thereby improving the production efficiency.

(2) Vibration assemblies are arranged outside the tank body in the centrifugal dewatering zone to provide an axial exciting force for centrifugal dewatering of a sediment material in the screen basket, such that the sediment material can intermittently vibrate up and down under the action of the axial exciting force and thus the sediment material become loose, which is conducive to the discharge of water through a material gap and further improves the centrifugal dewatering effect.

(3) A material receiving member is arranged between the screen basket and the tank body to receive the dewatered material out from the screen basket, and a discharge port can be formed on the material receiving member, such that the material obtained after the centrifugal dewatering can be discharged downward from the material receiving member to the screening zone.

(4) An upper surface of the material receiving member is lower than a top edge of the screen basket main body, and the top edge of the screen basket main body extends downward and is connected to an inner ring edge of the material receiving member, such that the material receiving member and an inner wall of the tank body are combined to form a groove structure for temporarily storing the dewatered material, which can increase an amount of the dewatered material received by the material receiving member. Moreover, a discharge port can be formed at a lower part of the upper surface of the material receiving member to facilitate the discharge of the dewatered material on the material receiving member.

(5) An upper side cavity wall of the guide cavity constitutes the material receiving member, which helps to reduce the number of components and makes a structure simple and reliable. In addition, a bottom of the guide cavity is lower than a bottom of the screen basket, which facilitates the smooth discharge of water separated by centrifugation and can also improve the drainage efficiency to some extent.

(6) A stirring mechanism is arranged in the mixing zone to thoroughly mix the initial material and the chemical agent, which can improve the efficiency of the flocculation reaction, thereby improving the dewatering and screening efficiency of the material.

(7) A pusher mechanism is arranged to push the material toward the stirring mechanism, which helps to improve the efficiency and uniformity of material mixing. In addition, an empty part is provided in a middle part of a push plate in the pusher mechanism, and a flexible diaphragm is arranged in the empty part, such that the diaphragm can generate reciprocating fluctuations under pressures at both sides of the diaphragm during a reciprocating movement process of the push plate to allow a solid substance in the material to be uniformly dispersed, which makes the flocculation reaction sufficient and improves the reaction efficiency.

(8) A jet mixing assembly is arranged to add the chemical agent to the mixing zone in the form of jets, which allows the chemical agent to quickly enter the interior of the initial material, thereby facilitating the thorough mixing of the chemical agent and the initial material.

(9) An inverted conical guide pipe is arranged above the sedimentation tank, such that the sediment material can fall into the sedimentation tank smoothly and thus can smoothly undergo the subsequent treatment procedures. A lower port of the guide pipe and a mouth of the sedimentation tank are arranged at a specified interval, which can prevent the sediment material from blocking the lower port of the guide pipe, and facilitate the movement of a liquid between the sedimentation tank and the guide pipe toward the overflow port. In addition, the mouth of the sedimentation tank is arranged in a tapered shape from top to bottom, such that the sediment material can gradually gather in a process of settling and fall into the middle part of the screen basket subsequently, thereby reserving a movement space for the centrifugal movement of the sediment material. A transition guide pipe is arranged to guide the sediment material into the screen basket from the sedimentation tank, and a lower end of the transition guide pipe is inside the screen basket, such that the sediment material can fall to the bottom of the screen basket smoothly, which can provide a large axial movement space for the centrifugal movement of the sediment material. The sediment material undergoes a centrifugal movement starting from a middle part of the bottom of the screen basket and climbs along a side wall of the screen basket, which improves the dewatering effect of the material.

(10) A first vibrating screen and a second vibrating screen are arranged in the screening mechanism to screen particles of different size grades in the dewatered material, and water generated during the screening process is discharged through the drain port below, which can further reduce a water content in the solid and can facilitate the subsequent separate treatment of the particles of different size grades.

### BRIEF DESCRIPTION OF THE DRAWINGS

FIG. 1 is a structural diagram of a flocculating, grading, and dewatering device provided in an embodiment of the present disclosure;

FIG. 2 is a schematic structural diagram of a mixing zone provided in an embodiment of the present disclosure;

FIG. 3 is a schematic structural diagram of an agent-feeding mechanism provided in an embodiment of the present disclosure;

FIG. 4 is a schematic structural diagram of a pusher mechanism provided in an embodiment of the present disclosure;

FIG. 5 is a schematic structural diagram of a flocculent settling zone provided in an embodiment of the present disclosure;

FIG. 6 is a schematic structural diagram of a centrifugal dewatering zone provided in an embodiment of the present disclosure;

FIG. 7 is a schematic diagram of the assembly of a screen basket and a guide cavity provided in another embodiment of the present disclosure;

FIG. 8 is a schematic structural diagram of an overflow dispersing pipe provided in an embodiment of the present disclosure; and

FIG. 9 is a schematic diagram of the assembly of a screening mechanism in a tank body provided in an embodiment of the present disclosure.

### REFERENCE NUMERALS

a represents an initial material, b represents a flocculation material, c represents an overflow liquid, d represents a sediment material, e represents a centrifugate, and f represents a dewatered material;
10 represents a tank body, 11 represents a feeding port, 12 represents an overflow port, 13 represents a centrifugate outlet, and 14 represents a drain port;
20 represents an agent-feeding mechanism, 21 represents an agent-feeding pipe, and 22 represents an agent-feeding pump;
30 represents a stirring mechanism, 31 represents a stirring shaft, and 32 represents a stirring blade;
40 represents a pusher mechanism, 41 represents a push plate, 42 represents a diaphragm, and 43 represents a pusher drive assembly;
50 represents a sedimentation tank, 51 represents a guide pipe, and 52 represents a transition guide pipe;
60 represents a screen basket, 61 represents a material receiving member, 62 represents a guide cavity, 63 represents a centrifugal drive assembly, and 64 represents a vibration assembly;
70 represents a screening mechanism, 71 represents a first vibrating screen, 72 represents a first collection tank, 73 represents a second vibrating screen, and 74 represents a second collection tank; and
80 represents an overflow dispersing pipe, 81 represents a mixed liquid outlet, 82 represents an overflow liquid pipe, and 83 represents a centrifugate pipe.

### DETAILED DESCRIPTION OF THE EMBODIMENTS

In order to make the objective, technical solutions, and advantages of the present disclosure more clear, the present disclosure is further described in detail below with reference to the drawings and examples. All other examples obtained by a person of ordinary skill in the art based on the examples of the present disclosure without creative efforts shall fall within the protection scope of the present disclosure.

Coal slime water is produced in a wet coal preparation process, which is a mixture of coal particles and water. In order to make the coal slime water meet the environmental protection requirements, the coal slime water needs to be further subjected to SLS. The flocculating, grading, and dewatering method is the main method for SLS of coal slime water, which is intended to mainly achieve the following objectives:

(1) A chemical agent is added to make a suspended solid in the coal slime water settled and separated in the form of large particles or loose flocs, which economically and effectively realizes a closed cycle of coal slime water and meets the requirements of environmental protection for coal slime water treatment.

(2) A vibrating centrifugal dewatering device is provided to dewater a coal material under the action of a centrifugal force, which achieves SLS, reduces a water content in a coal product, and improves the dewatering effect.

(3) A grading vibrating screen is provided to effectively screen a coarse-particle material and a fine-particle material, thereby meeting the requirements for subsequently recycling the material.

When the above objectives are achieved in the prior art, a related process is relatively complex; and multiple different devices are usually required to complete the entire process, and it takes time for materials to flow between the different devices, which increases a time gap between operations, results in low production efficiency, and cannot adapt to the needs of automated production.

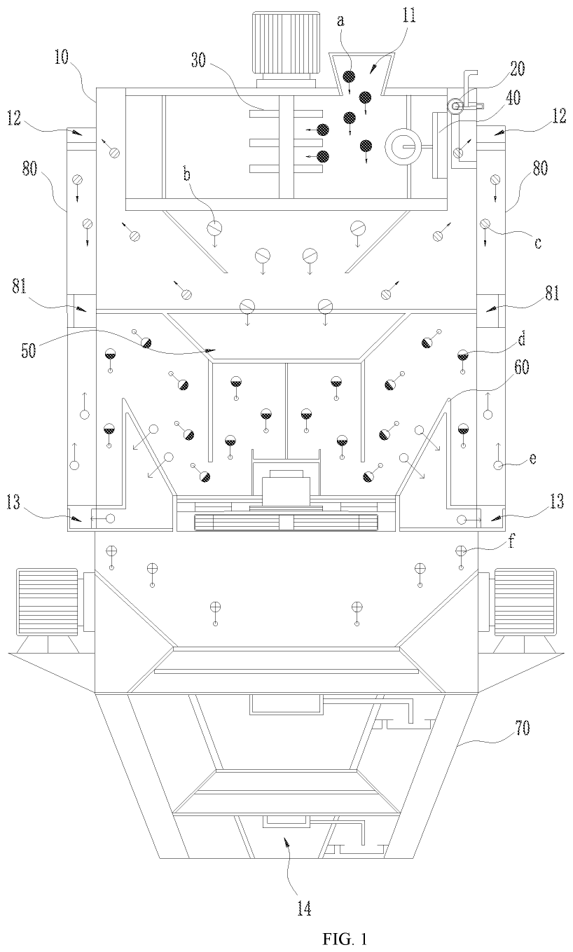

As shown in FIG. 1 to FIG. 9, in this embodiment, a flocculating, grading, and dewatering device is provided, including a tank body 10 arranged vertically, and a mixing zone, a flocculent settling zone, a centrifugal dewatering zone, and a particle screening zone that are sequentially arranged from top to bottom in the tank body 10. A feeding port 11 for feeding an initial material a into the mixing zone is formed at an upper end of the tank body 10. An agent-feeding mechanism 20 is arranged in the mixing zone, and a chemical agent participating in a flocculation reaction can be added to the initial material a in the mixing zone through the agent-feeding mechanism 20, such that the initial material a undergoes a flocculation reaction to produce a flocculation material b. A solid in the flocculation material b agglomerates and settles to form a sediment material d, and as the material participating in the flocculation reaction increases, water in the flocculation material b will gradually overflow to form an overflow liquid c. In the flocculent settling zone, the flocculation material b is separated into an upper layer (water with few impurities) and a lower layer (sediment material d), and a sedimentation tank 50 is provided in the flocculent settling zone to receive the sediment material d. An overflow port 12 for overflow of water above the sediment material d is formed on a side wall of the tank body 10, the overflow port 12 is lower than the feeding port 11 and higher than an inlet of the sedimentation tank 50, and a liquid flowing out from the overflow port 12 is denoted as the overflow liquid c.

The centrifugal dewatering zone is provided with a bowl-shaped screen basket 60 rotary-fitted on a screen basket seat and a centrifugal drive assembly 63 that drives the screen basket 60 to rotate; the screen basket seat is fixedly connected to an inner wall of the tank body 10 in the centrifugal dewatering zone; a rotating shaft of the screen basket 60 is arranged in a vertical direction; liquid-through holes for water separated from the sediment material d to pass through are formed on a side wall of the screen basket 60; a guide cavity 62 communicating with the liquid-through holes is formed on an outer peripheral side of the screen basket 60; and the guide cavity 62 is in seal fit with an outer side wall of the screen basket 60 and an inner wall of the tank body 10, and a centrifugate outlet 13 communicating with the guide cavity 62 is formed on the tank body 10. When in use, the screen basket 60 rotates under the driving of the centrifugal drive assembly 63. During the rotation, the sediment material d is discharged from the sedimentation tank 50 into the screen basket 60 and undergoes a centrifugal movement in the screen basket 60; and an inner side wall of the screen basket 60 is inclined (that is, a mouth of the screen basket 60 is flared from bottom to top), such that the sediment material d in the screen basket 60 climbs up along the wall of the screen basket 60 during the centrifugal movement until the sediment material is removed out of the mouth of the screen basket. In a process of the sediment material d climbing up along the screen basket 60, since the sediment material d itself is also subjected to a centrifugal force, water in the sediment material will be discharged through the liquid-through holes on the side wall of the screen basket 60 to the guide cavity 62, and then flows to the centrifugate outlet 13. This solution can not only achieve centrifugal dewatering, but also achieve the purpose of subjecting the sediment material d to further SLS.

The dewatered material f obtained after the centrifugal dewatering has a relatively low water content, but there are particles of different size grades. In order to facilitate the subsequent separate utilization of the particles of different size grades, a screening mechanism 70 is provided in the particle screening zone, and the screening mechanism 70 can screen the particles of different size grades in the dewatered material f discharged from the screen basket 60. During the screening process, water in the dewatered material f will pass through screen meshes to be under the screen, and thus water generated in the process of screening the dewatered material f by the screening mechanism 70 will accumulate at the bottom of the tank body 10. A drain port 14 for discharging the water generated in the screening process is formed at the bottom of the tank body 10, which helps to timely discharge the water accumulating at the bottom of the tank body 10.

An overflow dispersing pipe 80 is also provided, and the overflow dispersing pipe 80 communicates with the overflow port 12 and the centrifugate outlet 13; a mixed liquid outlet 81 for discharging an overflow liquid c and/or a centrifugate e is formed on the overflow dispersing pipe 80; and the overflow liquid c discharged through the overflow port 12 and the centrifugate e discharged through the centrifugate outlet 13 are collected by the overflow dispersing pipe 80, and then discharged through the mixed liquid outlet 81 on the overflow dispersing pipe 80. Specifically, the overflow dispersing pipe 80 is arranged outside the tank body 10, and is formed by splicing an overflow liquid pipe 82 and a centrifugate pipe 83 that are arranged correspondingly up and down; the mixed liquid outlet 81 is formed at an intersection of the overflow liquid pipe 82 and the centrifugate pipe 83; and an upper nozzle of the overflow liquid pipe 82 is connected to the overflow port 12, and a lower nozzle of the centrifugate pipe 83 is connected to the centrifugate outlet 13.

In the flocculating, grading, and dewatering device provided in this embodiment, the initial material a is fed through the feeding port at an upper end of the tank body 10, then the chemical agent is added to the initial material a through the agent-feeding mechanism 20 in the mixing zone to conduct a flocculation reaction, and after the initial material a undergoes the flocculation reaction, a sediment material d produced from the initial material a settles into the sedimentation tank 50 and a liquid above the sediment material d overflows through an overflow port 12; in the centrifugal dewatering zone, the screen basket 60 is allowed to rotate, such that the sediment material d falling into the screen basket 60 undergoes a centrifugal movement, water in the sediment material d is separated, moves into the guide cavity 62 through a liquid-through hole on a side wall of the screen basket 60, and then is discharged through the centrifugate outlet 13, and then a dewatered material f obtained after the centrifugal dewatering of the sediment material d in the screen basket 60 is removed out of the screen basket 60; in the particle screening zone, the screening mechanism 70 screens particles of different size grades in the dewatered material f discharged from the screen basket 60, and water generated during the screening process flows downward and is discharged through the drain port 14; and liquids discharged through the centrifugate outlet 13 and the overflow port 12 are combined through the overflow dispersing pipe 80, and then discharged through a mixed liquid outlet 81 of the overflow dispersing pipe 80. With the above solution, the flocculent settling, dewatering, and grading treatments can be conducted on a water-containing material at once, which helps to improve the dewatering effect and can also achieve the purpose of screening solid particles, thereby improving the production efficiency.

The centrifugal drive assembly 63 above is composed of a rotary motor.

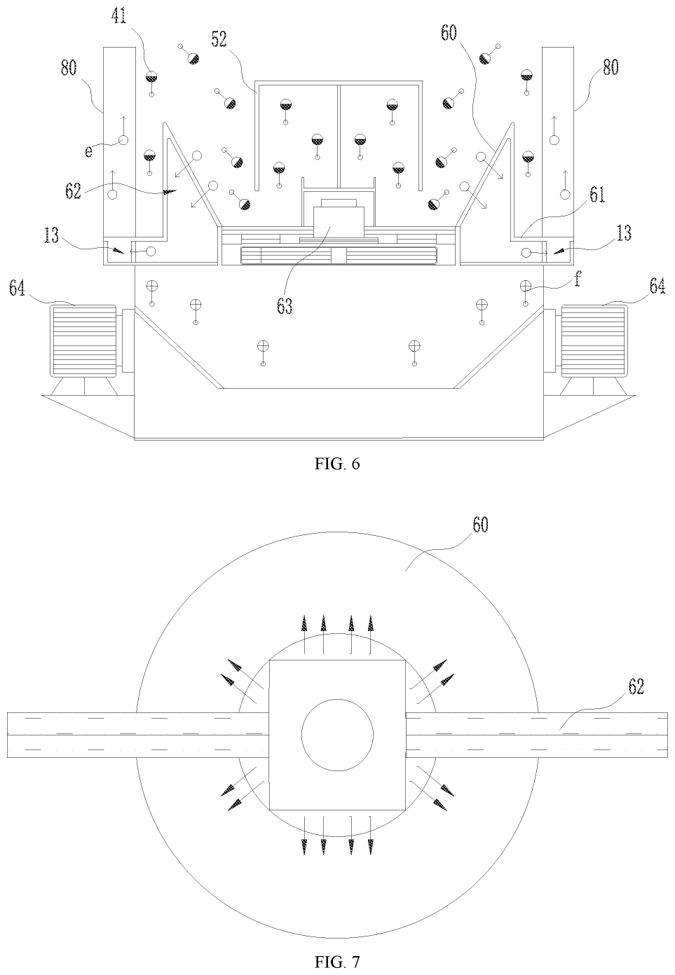

As shown in FIG. 1 and FIG. 6, vibration assemblies 64 may also be provided at an outer side of the tank body 10 in the centrifugal dewatering zone, and the vibration assemblies 64 may be arranged at a specified interval along a circumference of the tank body 10; and the vibration assemblies 64 may be configured to drive the screen basket 60 to vibrate in an axial direction, such that the sediment material d in the screen basket 60 vibrates up and down. In this embodiment, vibration assemblies are arranged outside the tank body in the centrifugal dewatering zone to provide an axial exciting force for centrifugal dewatering of the sediment material d in the screen basket, such that the sediment material d can intermittently vibrate up and down under the action of the axial exciting force and thus the sediment material d become loose, which is conducive to the discharge of water through a material gap and further improves the centrifugal dewatering effect.

The vibration assembly 64 is composed of two vibrating motors that are equally spaced in a circumferential direction of the tank body 10. An axial exciting force is provided for the sediment material d in the screen basket 60 through the operation of the vibrating motors, and the axial exciting force is periodically upward and downward with the operation of the vibrating motors, such that the sediment material d in the screen basket 60 can climb up in a stepped route under the action of a centrifugal force and the axial exciting force.

The sediment material d enters the centrifugal dewatering zone from the sedimentation tank 50 in the flocculent settling zone, then the sediment material d moves forward pulsatingly under the combined action of the centrifugal force and the axial exciting force, and a centrifugate e is discharged through the holes on the screen basket. The dewatering of the material is completed in the process of the sediment material d passing through the screen basket 60 gradually. When the sediment material d enters the screen basket 60 and is about to leave the screen basket 60 (at which point the dewatering is completed), with the gradual increase in the gyration radius and the tangential speed of the sediment material d, the centrifugal force generated increases, which is conducive to the discharge of water that is difficult to remove in the sediment material d. The dewatered material f enters the particle screening zone, and the centrifugate e enters the overflow dispersing pipe along the guide cavity 62 and is discharged together with the overflow liquid. In addition, since the sediment material d is in a loose state during a movement-stop alternating process of the sediment material d, water can be easily discharged through gaps in the material, thereby improving the dewatering effect.

As shown in FIG. 6 and FIG. 7, the screen basket 60 may include a screen basket main body and a material receiving member 61; a passage gap for the dewatered material f to pass may be formed between the screen basket main body and the inner wall of the tank body 10; the material receiving member 61 may be a ring-shaped member arranged concentrically with the screen basket main body and may be arranged in the passage gap; the material receiving member 61 may be configured to receive the dewatered material f that moves out from the screen basket main body to the passage gap; an inner ring edge of the material receiving member 61 may be in sealed connection with an edge of the screen basket main body; an outer ring edge of the material receiving member 61 may be in seal fit with the inner wall of the tank body 10; and a discharge port for downward discharging the dewatered material f may be formed on the material receiving member 61, and the discharge port and the guide cavity 62 may be arranged at a specified interval. The material receiving member 61 is arranged between the screen basket 60 and the tank body 10 to receive the dewatered material f out from the screen basket 60, and the discharge port is formed on the material receiving member 61, such that the material obtained after the centrifugal dewatering can be discharged downward from the material receiving member 61 to the screening zone.

An upper surface of the material receiving member 61 may be lower than a top edge of the screen basket main body; the top edge of the screen basket main body may extend downward and may be connected to the inner ring edge of the material receiving member 61; and the discharge port may be formed at a lower part of the upper surface of the material receiving member 61. An upper surface of the material receiving member 61 is lower than a top edge of the screen basket main body, and the top edge of the screen basket main body extends downward and is connected to the inner ring edge of the material receiving member, such that the material receiving member 61, a downward-extending part of the top edge of the screen basket main body, and an inner wall of the tank body 10 are combined to form a groove structure for temporarily storing the dewatered material f, which can increase an amount of the dewatered material f received by the material receiving member 61. Moreover, a discharge port can be formed at a lower part of the upper surface of the material receiving member 61 to facilitate the discharge of the dewatered material f on the material receiving member 61.

As shown in FIG. 1 and FIG. 6, in order to make the structure stable and improve the sealing performance of the guide cavity, the material receiving member 61 may preferably be integrated with the screen basket main body; the material receiving member 61 may be formed by an upper side cavity wall of the guide cavity 62; a bottom of the guide cavity 62 may be lower than a bottom of the screen basket 60; and the centrifugate outlet 13 may be arranged corresponding to the bottom of the guide cavity 62. An upper side cavity wall of the guide cavity constitutes the material receiving member, which helps to reduce the number of components and makes a structure simple and reliable. In addition, the bottom of the guide cavity is lower than the bottom of the screen basket, such that water can flow to a lower position, which facilitates the smooth discharge of water separated by centrifugation and can also improve the drainage efficiency to some extent.

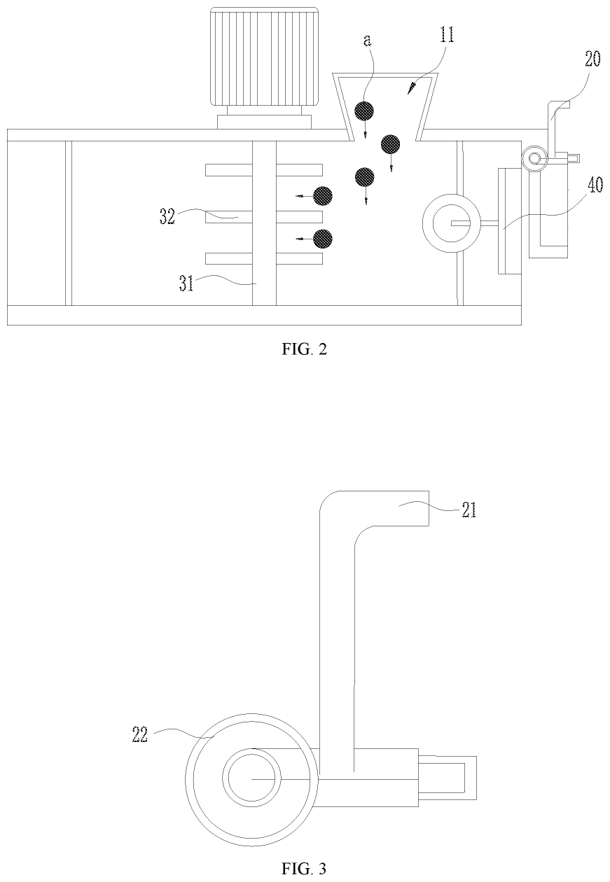

As shown in FIG. 1 and FIG. 2, a stirring mechanism 30 may also be provided in a middle part of the mixing zone, and the stirring mechanism 30 is configured to mix the initial material a and the chemical agent. The stirring mechanism 30 may include a stirring shaft 31 arranged vertically and stirring blades 32 arranged on the stirring shaft 31, and the stirring blades 32 may be arranged at a specific interval in axial and circumferential directions of the stirring shaft 31. The stirring shaft 31 is connected to a frequency conversion motor, and the frequency conversion motor is started to drive the stirring shaft 31 to rotate, which in turn drives the stirring blades 32 to rotate. When the stirring shaft 31 rotates, a mixed liquid in the mixing zone is stirred by the stirring blades 32 on the stirring shaft 31, such that the solid substance and the chemical agent in the mixed liquid can be uniformly dispersed, thereby improving the flocculation reaction efficiency. The stirring mechanism 30 is arranged in the mixing zone to thoroughly mix the initial material a and the chemical agent, which can improve the efficiency of the flocculation reaction, thereby improving the dewatering and screening efficiency of the material. Materials to be rapidly mixed can be stirred by the stirring mechanism 30 to be thoroughly mixed, thereby achieving the purpose of rapidly and thoroughly mixing the materials.

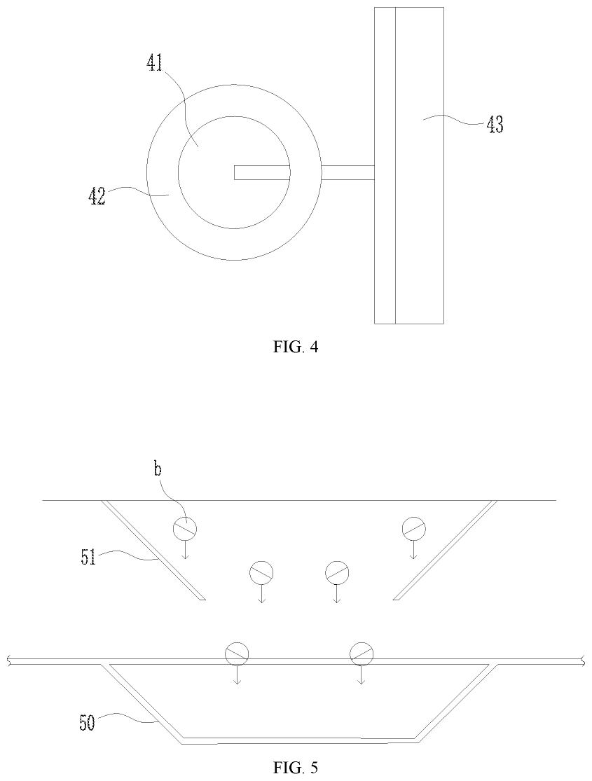

As shown in FIG. 1, FIG. 2, and FIG. 4, a pusher mechanism 40 for pushing the initial material a toward the stirring mechanism 30 may also be provided in the mixing zone; the pusher mechanism 40 may include a push plate 41 movably assembled in a radial direction of the tank body 10; an empty part may be provided in a middle part of the push plate 41, and a flexible diaphragm 42 may be arranged in the empty part; the diaphragm 42 may be configured to generate a fluctuation during a reciprocating movement process of the push plate 41 and make a solid substance dispersed in the material; and the push plate 41 may be connected to a pusher drive assembly 43 that adjusts a radial movement of the push plate along the tank body 10.

As shown in FIG. 4, the pusher mechanism 40 can also be referred to as a diaphragm agitation mechanism, the push plate 41 is connected to the pusher drive assembly 43, and the pusher drive assembly 43 can drive the push plate 41 to move toward/away from the stirring mechanism 30. When at work, the electric pusher drive assembly 43 drives the push plate 41 to reciprocate, such that the diaphragm 42 on the push plate 41 is agitated back and forth, and the initial material a is agitated to quickly reach the stirring mechanism 30, which increases a mixing speed and an amount of the material fed.

The pusher mechanism 40 is arranged to quickly push the material to the stirring mechanism 41, which helps to improve the efficiency and uniformity of material mixing. In addition, the empty part is provided in the middle part of the push plate 41 in the pusher mechanism 40, and a flexible diaphragm is arranged in the empty part, such that the diaphragm 42 can generate reciprocating fluctuations under pressures at both sides of the diaphragm during a reciprocating movement process of the push plate 41 to allow a solid substance in the material to be uniformly dispersed, which makes the flocculation reaction sufficient and improves the reaction efficiency.

The pusher drive assembly 43 may be composed of a piston rod of an electric cylinder/air cylinder/hydraulic cylinder, and a cylinder body of the electric cylinder/air cylinder/hydraulic cylinder may be connected to the tank body 10.

As shown in FIG. 1 to FIG. 3, the above agent-feeding mechanism 20 may be composed of a jet mixing assembly; the jet mixing assembly may include an agent-feeding pipe 21 and an agent-feeding pump 22; and an inlet of the agent-feeding pump 22 may be connected to an outlet of the agent-feeding pipe 21, and the agent-feeding pump may be configured to spray the chemical agent flowing into an a inlet end of the agent-feeding pipe 21 into the initial material a. The jet mixing assembly can pump the chemical agent into the mixed liquid in the mixing zone in the form of jets, thereby improving the speed of thorough mixing. A pipe can also be arranged at an outlet of the agent-feeding pump 22, and a tail end of the pipe preferably can extend into the mixed liquid in the mixing zone, which can increase the mixing efficiency. An existing pump can be adopted as the agent-feeding pump 22, as long as a speed of feeding the chemical agent can be increased. The jet mixing assembly is arranged to add the chemical agent to the mixing zone in the form of jets, which allows the chemical agent to quickly enter the interior of the initial material, thereby facilitating the thorough mixing of the chemical agent and the initial material.

The chemical agent (flocculant or coagulant) enters the jet mixing assembly through the agent-feeding pipe 21, and the jet mixing assembly is controlled by a controller to inject the flocculant or coagulant into the mixing zone, which has high automation degree, stable performance during operation, and convenient operations, and accelerates the mixing of materials.

As shown in FIG. 1 and FIG. 5, the flocculent settling zone may be further provided with an inverted conical guide pipe 51, and the guide pipe 51 may be arranged above the sedimentation tank 50; an upper port of the guide pipe 51 may communicate with the mixing zone, and a lower port of the guide pipe 51 and a mouth of the sedimentation tank 50 may be arranged at a specified interval. The inverted conical guide pipe 51 is adopted to guide a falling range and a falling direction of the sediment material d in the flocculation material b, such that the sediment material d can fall into the sedimentation tank smoothly and accurately. Moreover, with the accumulation of the sediment material d in the guide tube 51, a downward extruding force is generated among the materials, which also helps to increase a settling speed of the sediment material d.

The flocculation material b falls from the mixing zone to the flocculent settling zone, during which the conical surface of the guide tube 51 accelerates the falling of the flocculation material b, and the flocculation material b settles to the sedimentation tank 50 for sedimentation under gravitational potential energy.

The guide tube 51 can also be replaced by an inclined plate, and the inclined plate can enclose along the circumference of the tank body 10 to assemble a guide structure, as long as the above functions can be achieved.

As shown in FIG. 1, FIG. 5, and FIG. 6, a mouth of the sedimentation tank 50 may be arranged in a tapered shape from top to bottom, such that the sediment material d can easily enter and gradually gather in the middle part of the sedimentation tank 50 until it finally falls to the bottom of the sedimentation tank 50, which can effectively prevent the sediment material d from falling outside the sedimentation tank. A lower end of a tank wall of the sedimentation tank 50 may extend downward to form a transition guide pipe 52; a lower end of the transition guide pipe 52 may extend into the screen basket 60 and may be arranged at a specified interval from the bottom of the screen basket 60; a projection range of the transition guide pipe 51 on the bottom of the screen basket 60 may be smaller than an arrangement range of the bottom of the screen basket 60; and the transition guide pipe 52 may be configured to guide the sediment material d into the screen basket 60, which ensures that the sediment material d can reliably enter the screen basket 60 to undergo centrifugal dewatering.

The transition guide pipe 52 may be provided with division plates vertically arranged to evenly divide a cavity of the transition guide pipe 52, such that the sediment material d entering the screen basket 60 can be uniformly distributed, which helps to improve the efficiency and effect of centrifugal dewatering.

The inverted conical guide pipe 51 is arranged above the sedimentation tank 50, such that the sediment material d can fall into the sedimentation tank 50 smoothly and thus can smoothly undergo the subsequent treatment procedures. The lower port of the guide pipe 51 and the mouth of the sedimentation tank 50 are arranged at a specified interval, which can prevent the sediment material d from blocking the lower port of the guide pipe 51, and facilitate the movement of a liquid between the sedimentation tank 50 and the guide pipe 51 toward the overflow port. In addition, the mouth of the sedimentation tank 50 is arranged in a tapered shape from top to bottom, such that the sediment material d can gradually gather in a process of settling and fall into the middle part of the screen basket subsequently, thereby reserving a movement space for the centrifugal movement of the sediment material d. The transition guide pipe 51 is arranged to guide the sediment material d into the screen basket from the sedimentation tank 50, and a lower end of the transition guide pipe 51 is inside the screen basket, such that the sediment material d can fall to the bottom of the screen basket smoothly, which can provide a large axial movement space for the centrifugal movement of the sediment material d. The sediment material d undergoes a centrifugal movement starting from a middle part of the bottom of the screen basket and climbs along a side wall of the screen basket, which improves the dewatering effect of the material.

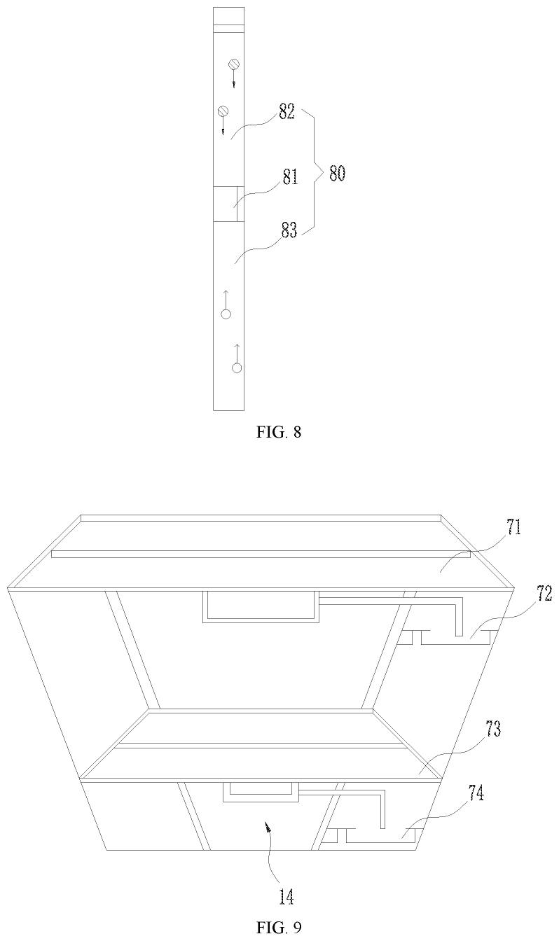

As shown in FIG. 1 and FIG. 9, the screening mechanism 70 may include a first vibrating screen 71 and a second vibrating screen 73 that are arranged in a vertical direction at a specified interval; the first vibrating screen 71 and the second vibrating screen 73 may be configured to achieve vibratory screening of particles of different size grades; a sieve fraction of the first vibrating screen 71 may be larger than a sieve fraction of the second vibrating screen 73; and a part of the tank body 10 corresponding to the particle screening zone may be in an inverted cone shape.

The first vibrating screen 71 may include a first screen mesh arranged horizontally and a first vibrator connected to the first screen mesh. After the dewatered material f falls on the first screen mesh, the first vibrator vibrates to make the dewatered material f gradually loose and increase the screening efficiency of the first screen mesh for the dewatered material f, such that fine particles meeting particle size requirements and water separated due to the vibration during the screening process pass through the first screen mesh and reach the second vibrating screen 73 below. Coarse particles that do not meet the particle size requirements are retained on the first vibrating screen 71, which are to be collected.

Similarly, the second vibrating screen 73 may include a second screen mesh arranged horizontally and a second vibrator connected to the second screen mesh. When the fine particles and water passing through the first screen mesh fall on the second screen mesh, the second vibrator vibrates to make the fine particles loose and increase the screening efficiency of the second screen mesh for the fine particles, such that smaller particles meeting emission requirements among the fine particles and water generated during the screening process pass through the second screen mesh and fall to the bottom of the tank body 10, and then the water and smaller particles accumulating at the bottom of the tank body 10 are discharged through the drain port. The particles retained on the second screen mesh are to be collected, and a particle size of the particles on the second screen mesh is smaller than a particle size of the particles on the first screen mesh.

The first vibrating screen 71 and the second vibrating screen 73 can screen out the particles of two different size grades in the dewatered material, separately. In order to facilitate the separate collection of the particles retained on the first screen mesh and the second screen mesh, the following preferred embodiment may be adopted: a side of the first vibrating screen 71 is provided with a first collection tank 72 configured to collect the particles retained on the first vibrating screen 71, and a side of the second vibrating screen 73 is provided with a second collection tank 74 configured to collect the particles retained on the second vibrating screen 73. In addition, in order to improve the collection efficiency, the first screen mesh and the second screen mesh can be in an inclined arrangement, the first collection tank 72 may be arranged corresponding to a lower end of the first screen mesh, and the second collection tank 74 may be arranged corresponding to a lower end of the second screen mesh, such that, during a vibratory screening process, the materials retained on the first screen mesh and the second screen mesh can respectively move to the first collection tank 72 and the second collection tank 74 under the action of their own weight and the vibration.

Water produced by the first vibrating screen 71 and the second vibrating screen 73 during a vibratory screening process may be discharged through the drain port 14.

The first vibrating screen 71 and the second vibrating screen 73 are arranged in the screening mechanism to screen particles of different size grades in the dewatered material, and water generated during the screening process is discharged through the drain port below, which can further reduce a water content in the solid on the one hand and can also facilitate the subsequent separate treatment of the particles of different size grades on the other hand.

As shown in FIG. 9, the screening mechanism 70 can also be implemented according to the following solution:

The screening mechanism 70 includes a coarse-particle vibrating screen, a fine-particle vibrating screen, a coarse-particle oversize collection tank, and a fine-particle oversize collection tank, where the coarse-particle vibrating screen includes a coarse-particle screen mesh and a coarse-particle vibrator, and the fine-particle vibrating screen includes a fine-particle screen mesh and a fine-particle vibrator. In a specific implementation, the dewatered material f enters the coarse-particle vibrating screen from the centrifugal dewatering zone, and a coarse-particle material with a particle size of about 0.5 mm or more is screened out through the coarse-particle screen mesh and then collected by the coarse-particle oversize collection tank. A material passing through the coarse-particle screen mesh enters the fine-particle vibrating screen together with water passing through the coarse-particle screen mesh for further screening; and a fine-particle material with a particle size of about 0.5 mm or lower is screened out through the fine-particle screen mesh and then collected by the fine-particle oversize collection tank. The water separated from the coarse-particle material flows out through the drain port together with the water separated from the fine-particle material. The operation of the coarse (fine)-particle vibrator drives the coarse (fine)-particle vibrating screen and the coarse (fine)-particle screen mesh to vibrate, which increases the vibration efficiency of the material, improves the screening efficiency, enhances the coarse and fine-particle screening effects, and can achieve the purpose of separating coarse and fine particles.

As shown in FIG. 1, parts of the tank body 10 corresponding to the mixing zone, the flocculent settling zone, and the centrifugal dewatering zone all have a cylindrical structure, and a tank structure corresponding to the particle screening zone is a conical structure.

A specific working process of the flocculating, grading, and dewatering device provided in this embodiment is as follows:

In the mixing zone, an initial material a falls freely from the feeding port 11 at the top of the tank body 10 under the gravity action; the jet mixing assembly pumps a chemical agent into the initial material a in the mixing zone in the form of jets, and the pusher mechanism 40 pushes the initial material a falling from the feeding port 11 and/or the added chemical agent toward the stirring mechanism 30; and the stirring mechanism 30 stirs the initial material a and the chemical agent in the mixing zone to achieve the thorough mixing of the two and allow a flocculation reaction, and a mixture of the initial material a and the chemical agent is denoted as a flocculation material b.

In the flocculent settling zone, a material in the flocculation material b that settles due to the flocculation reaction (referred to as a sediment material d) is guided by the guide pipe 51 into the sedimentation tank 50; and as an amount of the initial material a added to the feeding port 11 continues to increase, an upper liquid of the flocculation material b overflows through the overflow port 12 (the overflowing liquid is denoted as an overflow liquid c) into the overflow liquid pipe 82.

In the centrifugal dewatering zone, the rotating screen basket 60 receives the sediment material d discharged from the sedimentation tank 50 above, and the vibration assembly 64 provides an axial exciting force for the screen basket 60, such that the sediment material d in the screen basket 60 climbs pulsatingly toward the mouth of the screen basket, moves out of the mouth of the screen basket (a material out of the mouth is denoted as a dewatered material f) and falls on the material receiving member 61, and finally is discharged through a discharge port on the material receiving member 61 to the screening mechanism. During the process of the sediment material d climbing along the side wall of the screen basket 60 toward the mouth of the screen basket, water in the sediment material d is separated due to a centrifugal force, is discharged into the guide cavity 62 through the liquid-through hole of the screen basket 60 (the liquid discharged into the guide cavity 62 is denoted as a centrifugate e), and finally flows out through the centrifugate outlet 13 into the centrifugate pipe 83; and the centrifugate e in the centrifugate pipe 83 and the overflow liquid c in the overflow liquid pipe 82 are together discharged through the mixed liquid outlet.

The dewatered material f reaches the particle screening zone, and particles of different size grades in the dewatered material f are screened out through vibration by the first vibrating screen 71 and the second vibrating screen 73, and then collected by the first collection tank 72 and the second collection tank 74, such as to achieve the purpose of screening the coarse and fine particles in the dewatered material f. Water generated during the screening process falls step by step and finally reaches the drain port, and thus accumulated water can be discharged by opening the drain port.

In this embodiment, the mixing and flocculent settling, vibrating centrifugal dewatering, and secondary vibratory screening are combined, such that water-containing materials can be subjected to thorough mixing, flocculent settling, and secondary screening at once. On the one hand, the requirements of reprocessing or subsequent treatment of materials are met, and on the other hand, the flocculating, dewatering, and grading are effectively combined to solve the problem that the existing gradual flocculating, dewatering, and grading processes for materials are complicated, which reduces the material treatment time, simplifies the material treatment steps, and achieves the purpose of automatic integration of material flocculating, dewatering, and grading.

Those skilled in the art should understand that the above are only some specific examples of the present disclosure, rather than all examples of the present disclosure. It should be pointed out that many modifications and improvements can also be made by those of ordinary skill in the art, and all modifications or improvements that do not go beyond the claims should be regarded as within the protection scope of the present disclosure.

What is claimed is:

1. A flocculating, grading, and dewatering device, comprising: a tank body arranged vertically, a mixing zone, a flocculent settling zone, a centrifugal dewatering zone, and a particle screening zone;
wherein the mixing zone, the flocculent settling zone, the centrifugal dewatering zone, and the particle screening zone are sequentially arranged from a top to a bottom in the tank body;
a feeding port for feeding an initial material into the mixing zone is formed at an upper end of the tank body;
an agent-feeding mechanism is provided in the mixing zone, and the agent-feeding mechanism is configured to add a chemical agent participating in a flocculation reaction to the initial material in the mixing zone;
the flocculent settling zone is provided with a sedimentation tank for receiving a sediment material settled from the mixing zone, an overflow port for an overflow of a liquid above the sediment material is formed on a side wall of the tank body in the flocculent settling zone, and the overflow port is lower than the feeding port and higher than an inlet of the sedimentation tank;
the centrifugal dewatering zone is provided with a rotary-fitted bowl-shaped screen basket and a centrifugal drive assembly for driving the rotary-fitted bowl-shaped screen basket to rotate, the rotary-fitted bowl-shaped screen basket is configured to receive the sediment material discharged from the sedimentation tank, a rotating shaft of the rotary-fitted bowl-shaped screen basket is arranged in a vertical direction, a plurality of liquid-through holes for water separated from the sediment material to pass through are formed on a side wall of the rotary-fitted bowl-shaped screen basket, a guide cavity communicating with the plurality of liquid-through holes is formed on an outer peripheral side of the rotary-fitted bowl-shaped screen basket, the guide cavity is in seal fit with an outer side wall of the rotary-fitted bowl-shaped screen basket and an inner wall of the tank body, respectively, and a centrifugate outlet communicating with the guide cavity is formed on the tank body;
the particle screening zone is provided with a screening mechanism, and the screening mechanism is configured to screen particles of different size grades in a dewatered material discharged from the rotary-fitted bowl-shaped screen basket; and a drain port for discharging water generated in a screening process is formed at a bottom of the tank body; and
an overflow dispersing pipe is also provided, and the overflow dispersing pipe communicates with the overflow port and the centrifugate outlet, respectively; and a mixed liquid outlet for discharging an overflow liquid and/or a centrifugate is formed on the overflow dispersing pipe.

2. The flocculating, grading, and dewatering device according to claim 1, wherein a plurality of vibration assemblies are also provided at an outer side of the tank body in the centrifugal dewatering zone, and the plurality of vibration assemblies are arranged at a first specified interval along a circumference of the tank body, and the plurality of vibration assemblies are configured to drive the rotary-fitted bowl-shaped screen basket to vibrate in an axial direction, such that the sediment material in the rotary-fitted bowl-shaped screen basket vibrates up and down.

3. The flocculating, grading, and dewatering device according to claim 1, wherein the rotary-fitted bowl-shaped screen basket comprises a screen basket main body and a material receiving member; a passage gap for the dewatered material to pass through is formed between the screen basket main body and the inner wall of the tank body; the material receiving member is a ring-shaped member arranged concentrically with the screen basket main body and is arranged in the passage gap; the material receiving member is configured to receive the dewatered material discharged from the screen basket main body; an inner ring edge of the material receiving member is in a sealed connection with an edge of the screen basket main body, an outer ring edge of the material receiving member is in a seal fit with the inner wall of the tank body; a discharge port for downward discharging the dewatered material is formed on the material receiving member, and the discharge port and the guide cavity are arranged at a specified interval.

4. The flocculating, grading, and dewatering device according to claim 3, wherein an upper surface of the material receiving member is lower than a top edge of the screen basket main body; the top edge of the screen basket main body extends downward and is connected to the inner ring edge of the material receiving member; and the discharge port is formed at a lower part of the upper surface of the material receiving member.

5. The flocculating, grading, and dewatering device according to claim 4, wherein the material receiving member is formed by an upper side cavity wall of the guide cavity; a bottom of the guide cavity is lower than a bottom of the rotary-fitted bowl-shaped screen basket; and the centrifugate outlet is arranged corresponding to the bottom of the guide cavity.

6. The flocculating, grading, and dewatering device according to claim 1, wherein a stirring mechanism for stirring and mixing the initial material and the chemical agent is further provided in a middle part of the mixing zone; and the stirring mechanism comprises a stirring shaft arranged vertically and a plurality of stirring blades arranged on the stirring shaft.

7. The flocculating, grading, and dewatering device according to claim 6, wherein a pusher mechanism for pushing the initial material toward the stirring mechanism is further provided in the mixing zone; the pusher mechanism comprises a push plate movably assembled in a radial direction of the tank body; an empty part is provided in a middle part of the push plate, and a flexible diaphragm is arranged in the empty part; the flexible diaphragm is configured to generate a fluctuation during a reciprocating movement process of the push plate and make a solid substance in the initial material disperse; and the push plate is connected to a pusher drive assembly configured to adjust a radial movement of the push plate along the tank body.

8. The flocculating, grading, and dewatering device according to claim 1, wherein the agent-feeding mechanism is composed of a jet mixing assembly; the jet mixing assembly comprises an agent-feeding pipe and an agent-feeding pump; the agent-feeding pump is connected in series to an outlet end of the agent-feeding pipe and is configured to spray the chemical agent flowing into an inlet end of the agent-feeding pipe into the initial material.

9. The flocculating, grading, and dewatering device according to claim 1, wherein the flocculent settling zone is further provided with an inverted conical guide pipe, and the inverted conical guide pipe is arranged above the sedimentation tank; an upper port of the inverted conical guide pipe communicates with the mixing zone, and a lower port of the inverted conical guide pipe and a mouth of the sedimentation tank are arranged at a first specified interval;
the mouth of the sedimentation tank is arranged in a tapered shape from the top to the bottom; a lower end of a tank wall of the sedimentation tank extends downward to form a transition guide pipe; a lower end of the transition guide pipe extends into the rotary-fitted bowl-shaped screen basket and is arranged at a second specified interval from a bottom of the rotary-fitted bowl-shaped screen basket; a projection range of the transition guide pipe on the bottom of the rotary-fitted bowl-shaped screen basket is smaller than an arrangement range of the bottom of the rotary-fitted bowl-shaped screen basket; and the transition guide pipe is configured to guide the sediment material into the rotary-fitted bowl-shaped screen basket.

10. The flocculating, grading, and dewatering device according to claim 1, wherein the screening mechanism comprises a first vibrating screen and a second vibrating screen, the first vibrating screen and the second vibrating screen are arranged in a vertical direction at a specified interval; the first vibrating screen and the second vibrating screen are configured to achieve a vibratory screening process of particles of different size grades; a sieve fraction of the first vibrating screen is larger than a sieve fraction of the second vibrating screen; a part of the tank body corresponding to the particle screening zone is in an inverted cone shape;
a side of the first vibrating screen is provided with a first collection tank configured to collect particles retained on the first vibrating screen, and a side of the second vibrating screen is provided with a second collection tank configured to collect particles retained on the second vibrating screen; and
water produced by the first vibrating screen and the second vibrating screen during the vibratory screening process is discharged through the drain port.

11. The flocculating, grading, and dewatering device according to claim 2, wherein the rotary-fitted bowl-shaped screen basket comprises a screen basket main body and a material receiving member; a passage gap for the dewatered material to pass through is formed between the screen basket main body and the inner wall of the tank body; the material receiving member is a ring-shaped member arranged concentrically with the screen basket main body and is arranged in the passage gap; the material receiving member is configured to receive the dewatered material discharged from the screen basket main body; an inner ring edge of the material receiving member is in a sealed connection with an edge of the screen basket main body, an outer ring edge of the material receiving member is in a seal fit with the inner wall of the tank body; a discharge port for downward discharging the dewatered material is formed on the material receiving member, and the discharge port and the guide cavity are arranged at a second specified interval.
